(19) United States
(12) Patent Application Publication
(10) Pub. No.: US 2009/0325525 A1
(43) Pub. Date: Dec. 31, 2009

(54) RECEIVER AND METHOD OF REDUCING OPERATING CURRENT THEREOF

(75) Inventor: Tatsuhiko MARUYAMA, Kawasaki (JP)

Correspondence Address: SUGHRUE MION, PLLC, 2100 PENNSYLVANIA AVENUE, N.W., SUITE 800, WASHINGTON, DC, 20037, US

(73) Assignee: NEC Electronics Corporation, Kawasaki (JP)

(21) Appl. No.: 12/491,604

(22) Filed: Jun. 25, 2009

(30) Foreign Application Priority Data
Jun. 27, 2008 (JP) 2008-168852

(51) Int. Cl. H04B 1/16; H04B 1/06

(52) U.S. Cl. 455/205; 455/230

(57) ABSTRACT

Disclosed is a receiver so adapted that even it receives a signal having the same communication frequency and frequency band as its own, restart of a receive-signal processor is inhibited for a fixed period of time if the receive signal is not a desired signal. The result is a reduction in power consumption. The receiver includes a start circuit for detecting a radio-frequency signal and outputting a start signal if a level of the detected radio-frequency signal is no less than a fixed level, and a receive-signal processor for receiving the start signal and starting a demodulating operation for demodulating the radio-frequency signal. The receive-signal processor includes a demodulator for reconstructing a demodulated signal from the radio-frequency signal, and a restart-inhibit controller for determining whether the demodulated signal is a desired signal and, if the demodulated signal is not a desired signal, outputting a restart-inhibit signal to the start circuit and causing the start circuit to inhibit output of the start signal for a fixed period of time.

### REFERENCE TO RELATED APPLICATION

This application is based upon and claims the benefit of the priority of Japanese patent application No. 2008-168852, filed on Jun. 27, 2008, the disclosure of which is incorporated herein in its entirety by reference thereto.

### TECHNICAL FIELD

This invention relates to a receiver and to a method of reducing operating current of the receiver. More particularly, the invention relates to a receiver having a start circuit for detecting a radio-frequency signal and starting the receiver proper.

### BACKGROUND

The spread of mobile wireless communication devices has been accompanied by the proposal of various techniques for lengthening battery drive time. One promising technique among these is to reduce power consumption using an RF signal detection and start circuit.

FIG. 7 is a block diagram of a conventional RF signal detection and start circuit described in Patent Document 1. As shown in FIG. 7, a radio-frequency-signal input terminal 601 is connected to a matching circuit 602 and sends the matching circuit 602 an externally input radio-frequency signal (RF signal). The matching circuit 602 matches the signal to a desired signal band and rejects signals that are outside of this band. The signal that has passed through the matching circuit 602 is input to a detecting circuit 603. Together with a capacitor 604 and amplifying circuit 605, the detecting circuit 603 constructs a detecting amplifier circuit for performing detection and amplification. The input impedance of the capacitor 604 and amplifying circuit 605 forms a low-pass filter for noise removal (band limiting). The amplified signal passes through a capacitor 606 and is output to a binarizing circuit 608 by a buffer circuit 607. A high-pass filter is formed by the input impedance of the capacitor 606 and buffer circuit 607 and removes noise. Finally, a digital signal produced by the binarizing circuit 608 is output from an output terminal 609. A DC offset signal possessed by the circuit itself and noise in the DC vicinity can be cut off by the radio-frequency start circuit shown in FIG. 7.

FIG. 8 is a block diagram of a conventional wireless communication device described in Patent Document 2. The wireless communication device of FIG. 8 is composed of a receiving circuit 701, a transmitting circuit 702, an auxiliary arithmetic unit 703, a main arithmetic unit 704, a peripheral circuit 705 and an external interface 706. The receiving circuit 701 subjects received radio waves to FSK demodulation, digitizes the signal and inputs the resultant signal to the auxiliary arithmetic unit 703. The auxiliary arithmetic unit 703 processes the preamble portion of the receive signal and, if the preamble is a prescribed start pattern, starts the main arithmetic unit 704 to thereby begin receive processing. Since the main arithmetic unit 704 usually is off during reception, processing in the absence of an incoming signal does not require power for the main arithmetic unit 704. A reduction in power consumption is achieved as a result.

### [Patent Document 1]

Japanese Patent Kokai Publication No. JP-P2005-184175A

### [Patent Document 2]

Japanese Patent Kokai Publication No. JP-A-10-28078

### SUMMARY

However, with the radio-frequency-detection start circuit described in Patent Document 1, if another wireless communication device whose frequency band is the same as that of the desired signal and whose protocol is the same exists in an area reached by radio waves, the circuit will detect the radio waves and output the start signal even if the transceiver to which the circuit belongs is not communicating. Owing to the start signal, there are instances where the transceiver starts up and consumes power despite the fact that communication is not being carried out.

With the wireless communication device described in Patent Document 2, whether or not it is necessary for the main arithmetic unit 704 to start requires FSK demodulation by the receiving circuit 701 and a determination by the auxiliary arithmetic unit 703. Accordingly, even if absence of a signal continues, it is necessary to periodically actuate the auxiliary arithmetic unit 703 in order to verify whether there is a signal or not, a demodulation operation must be performed by the receiving circuit 701 and whether there is a signal or not must be checked by the auxiliary arithmetic unit 703. Further, in order to activate the auxiliary arithmetic unit 703 periodically, it is required that the internal blocks of the wireless communication device operate at all times. The result is an increase in power consumption.

Thus there is demand for a receiver which will stand by with little power consumption if absence of a signal continues and which will not undergo a large increase in power consumption even if an unwanted signal is received, as in a case where the receiver receives a signal intended for another wireless communication device of the same frequency band and communication protocol.

According to a first aspect of the present invention, there is provided a receiver comprising; a start circuit that detects a radio-frequency signal and outputting a start signal if a level of the detected radio-frequency signal is no less than a fixed level, and a receive-signal processor that receives the start signal and starts a demodulating operation for demodulating the radio-frequency signal. The receive-signal processor includes: a demodulator that reconstructs a demodulated signal from the radio-frequency signal; and a restart-inhibit controller that determines whether the demodulated signal is a desired signal and, if the demodulated signal is not a desired signal, outputs a restart-inhibit signal to the start circuit and causes the start circuit to inhibit output of the start signal for a fixed period of time.

According to a second aspect of the present invention, there is provided a method of reducing operating current of a receiver having a start circuit and a receive-signal processor, the method comprising: the start circuit operating and the receive-signal processor ceasing operation in a standby state; when the start circuit detecting a radio-frequency signal and a level of the detected radio-frequency signal is no less than a fixed level, starting the receive-signal processor to perform a demodulating operation for reconstructing a demodulated signal from the radio-frequency signal and suspending operation of the start circuit; when the demodulated signal is a desired signal, continuing signal-receive processing until end of communication and returning to the standby state following end of communication; and when the demodulated signal is not a desired signal, setting the start circuit in such a manner that it will not start the receive-signal processor for a fixed period of time, and returning to the standby state after the setting is made.

The meritorious effects of the present invention are summarized as follows.

In accordance with the present invention, there is obtained a receiver which stands by with little consumption of power if absence of a signal continues, and which makes reduces an increase in power consumption even if an unwanted signal is received.

In accordance with the method of reducing operating current in a receiver according to the present invention, the operating current of a receiver when an unwanted signal has been received can be reduced.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram of a receiver according to an exemplary embodiment;

FIG. 2 is a block diagram of a receiver according to another exemplary embodiment;

FIG. 3 is a block diagram of a restart-signal inhibit controller in an exemplary embodiment;

FIGS. 4A and 4B are waveform diagrams of output current and output voltage, respectively, of a restart-signal inhibit controller in an exemplary embodiment;

FIGS. 5A and 5B are other waveform diagrams of output current and output voltage, respectively, of a restart-signal inhibit controller in an exemplary embodiment;

FIG. 6 is a flowchart of operation of a receiver in an exemplary embodiment;

FIG. 7 is a block diagram of a radio-frequency-detection start circuit according to the related art; and

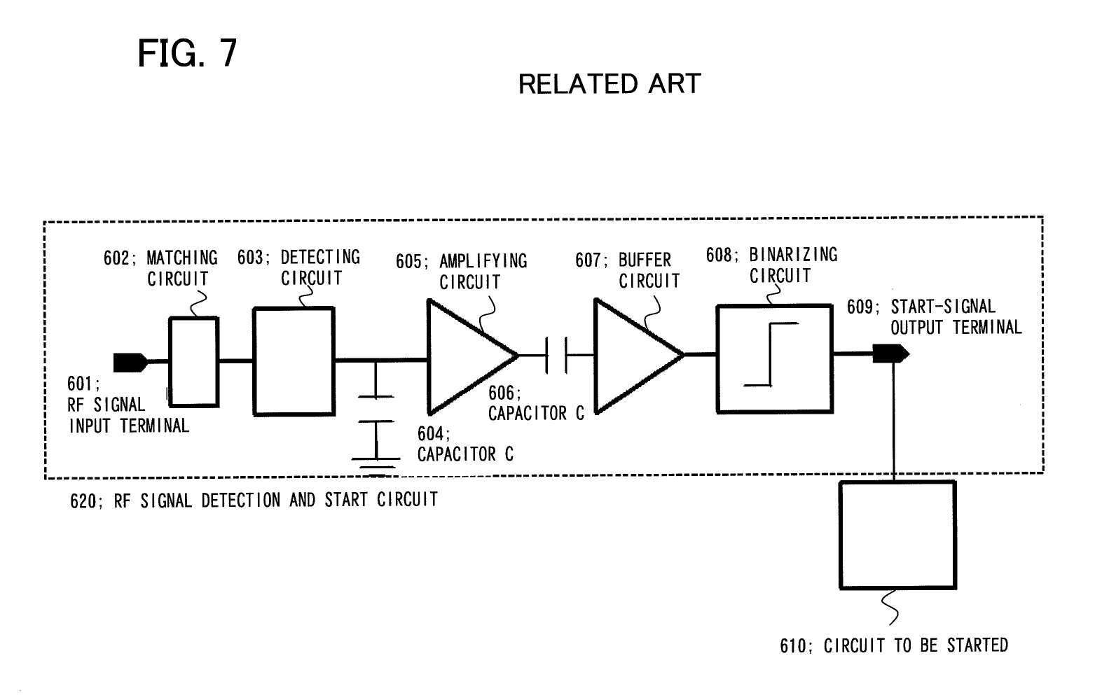

FIG. 8 is a block diagram of a wireless communication device according to the related art.

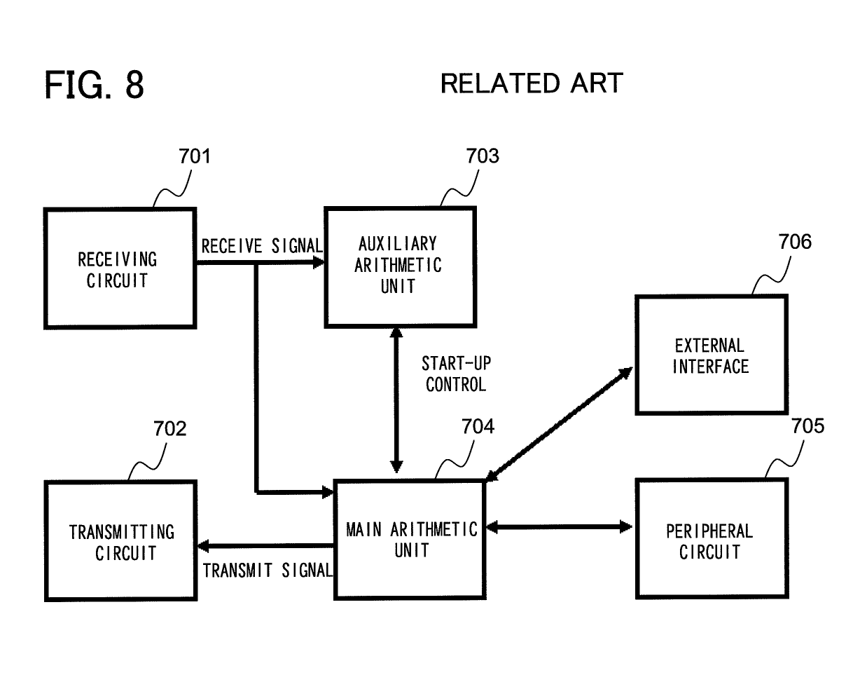

### PREFERRED MODES

Exemplary modes of the present invention will now be described with reference to the drawings as necessary.

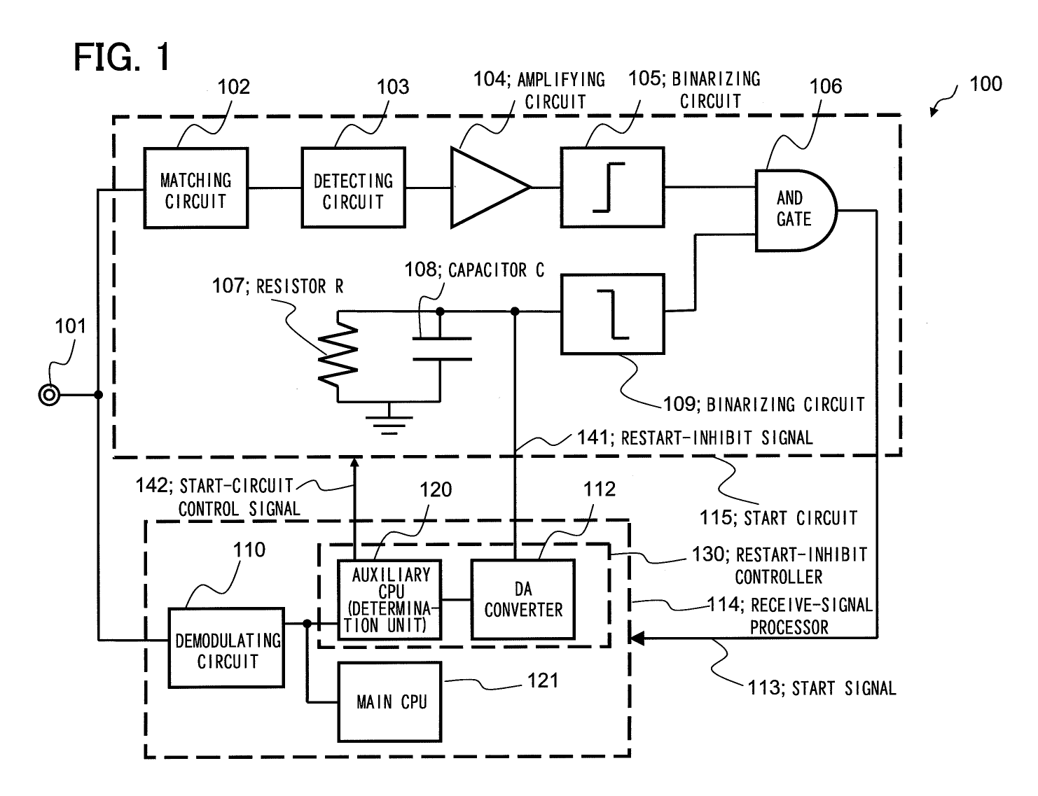

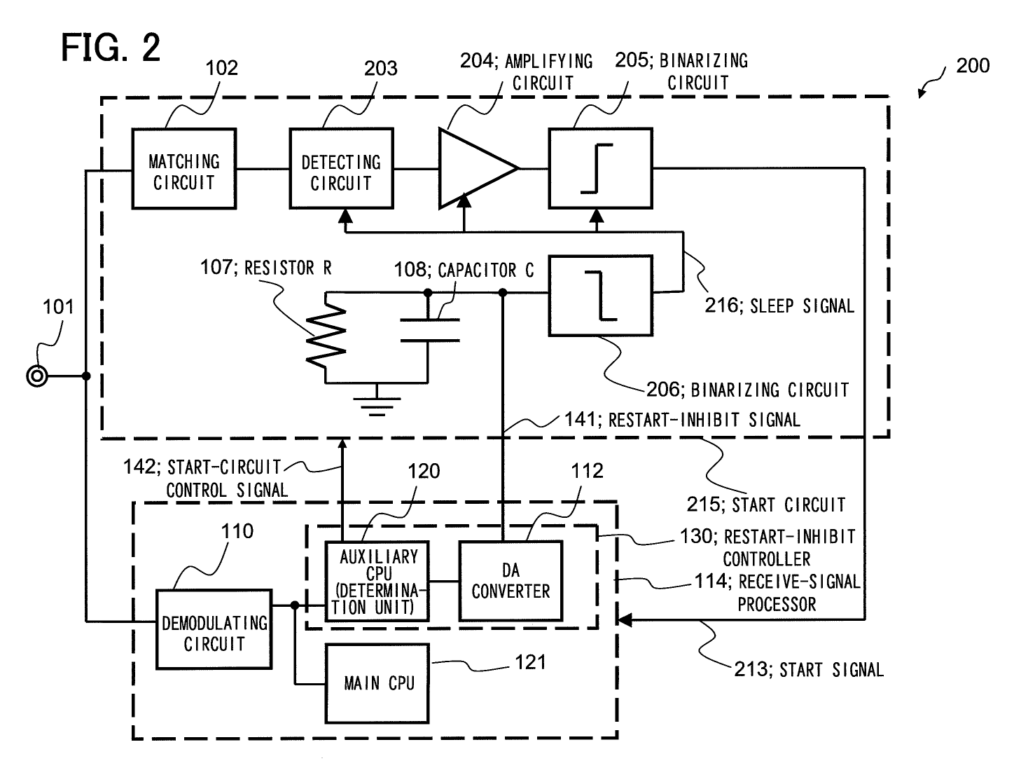

As illustrated in FIGS. 1 and 2, the receiver according to the exemplary embodiments has a start circuit (115, 215) for detecting a radio-frequency signal (101) and outputting a start signal (113, 213) if a level of the detected radio-frequency signal is no less than a fixed level; and a receive-signal processor 114 for receiving the start signal (113, 213) and starting a demodulating operation for demodulating the radio-frequency signal (101). The receive-signal processor 114 includes: a demodulator 110 for reconstructing a demodulated signal from the radio-frequency signal (101), and a restart-inhibit controller 130 for determining whether the demodulated signal is a desired signal and, if the demodulated signal is not a desired signal, outputting a restart-inhibit signal 141 to the start circuit (115, 215) and causing the start circuit (115, 215) to inhibit output of the start signal (113, 213) for a fixed period of time.

Further, as shown in FIGS. 1 and 2, the start circuit (115, 215) of receiver of the exemplary embodiments may be a start circuit (115, 215) that further includes a time-constant circuit (107, 108) for receiving a restart-inhibit signal 141 and inhibiting output of the start signal (113, 213) for a fixed period of time.

Further, as shown in FIGS. 1 and 2, the restart-inhibit controller 130 of the receiver of the exemplary embodiments may be a restart-inhibit controller 130 for determining whether the demodulated signal is a desired signal whenever the receive-signal processor 114 starts operating in response to receipt of the start signal (113, 213) from the start circuit (115, 215), and, if the demodulated signal is not the desired signal, counting the number of times the demodulated signal is not the desired signal and outputting the restart-inhibit signal in such a manner that the time during which the output of the start signal is inhibited is lengthened to the extent that the number of times the demodulated signal is not the desired signal continues.

Further, as shown in FIGS. 1, 2 and 3, the restart-inhibit controller 130 of the receiver of the exemplary embodiments may include: a determination unit 120 for determining whether the demodulated signal is a desired signal whenever the receive-signal processor 114 starts operating in response to receipt of the start signal (113, 213) from the start circuit (115, 215), counting the number of times the demodulated signal is not the desired signal if the demodulated signal is not the desired signal, and resetting the value of the count if the demodulated signal is the desired signal; and a DA converter (112, 306, 307) for outputting a current that conforms to the value of the count; wherein the restart-inhibit signal 141 is the current signal that is output from the DA converter (112, 306, 307).

Further, as shown in FIGS. 1 and 2, the start circuit (115, 215) of the receiver of the exemplary embodiments may be a start circuit that includes: a capacitor 108 for being charged to the restart-inhibit signal 141; a fixed resistor 107 for discharging a charge that has been charged in the capacitor 108; and a comparison circuit (109, 206) for inhibiting the output of the start signal (113, 213) if the charge that has been charged in the capacitor 108 is equal to or greater than a prescribed voltage.

Further, as shown in FIG. 2, the start circuit (215) of the receiver may cease operation for a fixed period time in response to receipt of the restart-inhibit signal 141.

Further, as illustrated in FIG. 2, the start circuit (215) of the receiver may further include: a matching circuit 102 for receiving a radio-frequency signal of a prescribed frequency band efficiently; a detecting circuit 203 for detecting in analog form the radio-frequency signal that has been matched by the matching circuit 102; an amplifying circuit 204 for amplifying an output from the detecting circuit 203; and a start-signal output circuit 205 for outputting the start signal 213 if the detection signal amplified by the amplifying circuit 204 is equal to or greater than a prescribed voltage; wherein the comparison circuit 206 suspends operation of the detecting circuit 203, amplifying circuit 204 and start-signal output circuit 205 if the charge that has been charged in the capacitor 108 is equal to or greater than a prescribed voltage.

Furthermore, as illustrated in FIGS. 1, 2 and 6, a method of reducing operating current of a receiver (100, 200) having a start circuit (115, 215) and a receive-signal processor 114 according to the exemplary embodiments is such that in a standby state, the start circuit (115, 215) operates and the receive-signal processor suspends operation (step 502); the start circuit (115, 215) detects a radio-frequency signal and, if a level of the detected radio-frequency signal is no less than a fixed level (“YES” at step 504), starts the receive-signal processor 114 and suspends operation of the start circuit (step 506); and the receive-signal processor 114 performs a demodulating operation for reconstructing a demodulated signal from the radio-frequency signal, continues signal-receive processing (step 509) until end of communication and returns to the standby state following end of communication if the demodulated signal is a desired signal (“YES” at step 507), sets the start circuit (115, 215) in such a manner that it will not start the receive-signal processor 114 for a fixed period of time (step 511) if the demodulated signal is not a desired signal (“NO” at step 507), and returns to the standby state (step 502) after the setting (step 511) is made.

Further, as illustrated in FIGS. 1, 2 and 6, the method of reducing operating current of the receiver of the exemplary embodiments is such that if the fact that the demodulated signal is not the desired signal continues whenever the receive-signal processor 114 starts, the fixed period of time over which the receive-signal processor 114 is set so as not to start is set to a longer fixed period of time (steps 510, 511) based upon the number of times in succession the demodulated signal is not the desired signal.

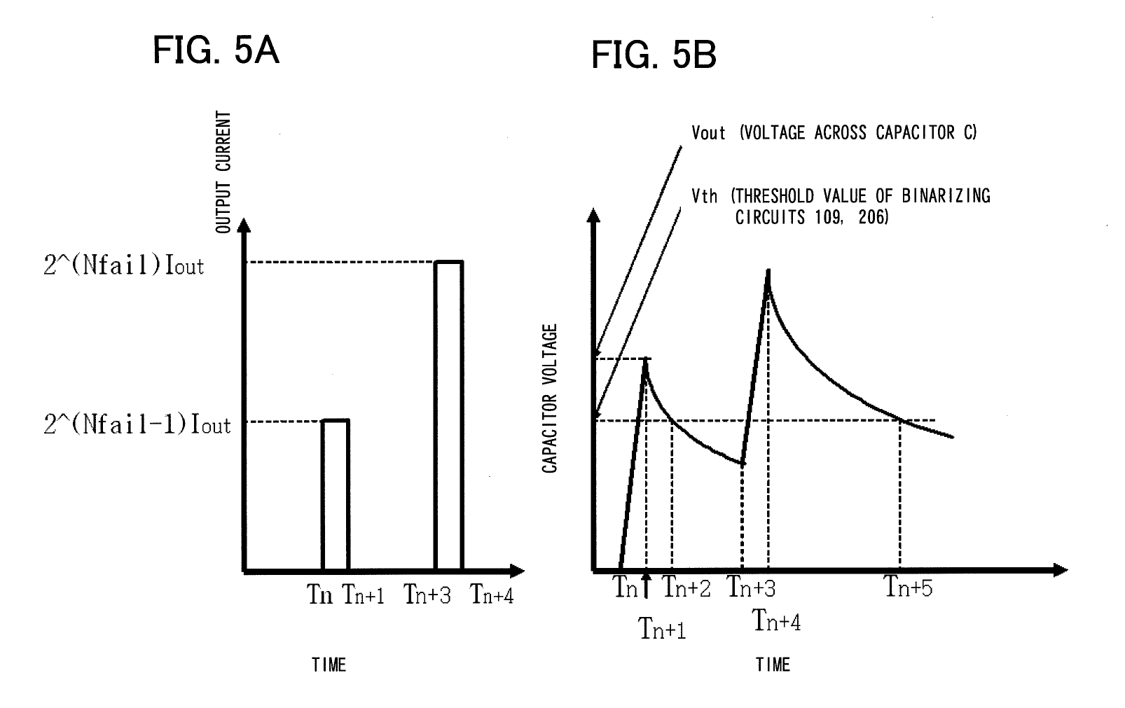

Further as shown in FIGS. 2 and 5, the method of reducing operating current of the receiver of the exemplary embodiment is such that if the demodulated is not the desired signal, both operations of the start circuit 215 and the receive-signal processor 114 are suspended for a fixed period of time (step 511) and the standby state is restored upon elapse of the fixed period of time (step 502).

Exemplary embodiments of the present invention will now be described in detail with reference to the drawings.

### First Exemplary Embodiment

FIG. 1 is a block diagram illustrating a receiver 100 according to a first exemplary embodiment. The receiver 100 of the first exemplary embodiment includes a start circuit 115 and a receive-signal processor 114. The start circuit 115 starts the receive-signal processor 114 if a signal that enters from an RF signal input terminal 101 contains a signal having a prescribed RF band. The receive-signal processor 114 demodulates the RF signal that has entered from the RF signal input terminal 101 and processes the receive data. Further, if the receiver is a wireless communication device, an antenna (not shown) may be connected externally of the RF signal input terminal 101.

The start circuit 115 includes a matching circuit 102 for receiving only a signal of a desired frequency band contained in the signal that has entered from the RF signal input terminal 101; a detecting circuit 103 for detecting the signal of the desired frequency band; an amplifying circuit 104 for amplifying the output of the detecting circuit 103; and a binarizing circuit 105 for comparing the amplified analog signal with a fixed reference value and converting the signal to a digital value. The start circuit 115 further includes a capacitor 108 charged to a restart-inhibit signal 141 that is output by the receive-signal processor 114; a resistor 107 for constantly discharging the charge that has been charged in the capacitor 108; a binarizing circuit 109 for comparing the voltage level of the restart-inhibit signal 141 with a fixed reference voltage and converting the level to an inverted digital value; and an AND gate 106 for outputting a start signal 113 if the outputs of the binarizing circuits 105 and 109 are both at the high level.

The receive-signal processor 114 includes a demodulating circuit 110 for digitally demodulating the RF signal that has entered from the RF signal input terminal 101; a main CPU 121 for data-processing the receive signal reconstructed by the demodulating circuit 110; and a restart-inhibit controller 130 for outputting a restart-inhibit signal 141 if the reconstructed receive signal is not the desired signal.

The restart-inhibit controller 130 includes an auxiliary CPU 120 and a DA converter 112. The auxiliary CPU 120 determines whether the reconstructed receive signal is the desired signal and decides a time period over which restart of the start circuit 115 is inhibited. The DA converter 112 converts the result of the determination by the auxiliary CPU 120 to a current value and outputs the current value as the restart-inhibit signal 141.

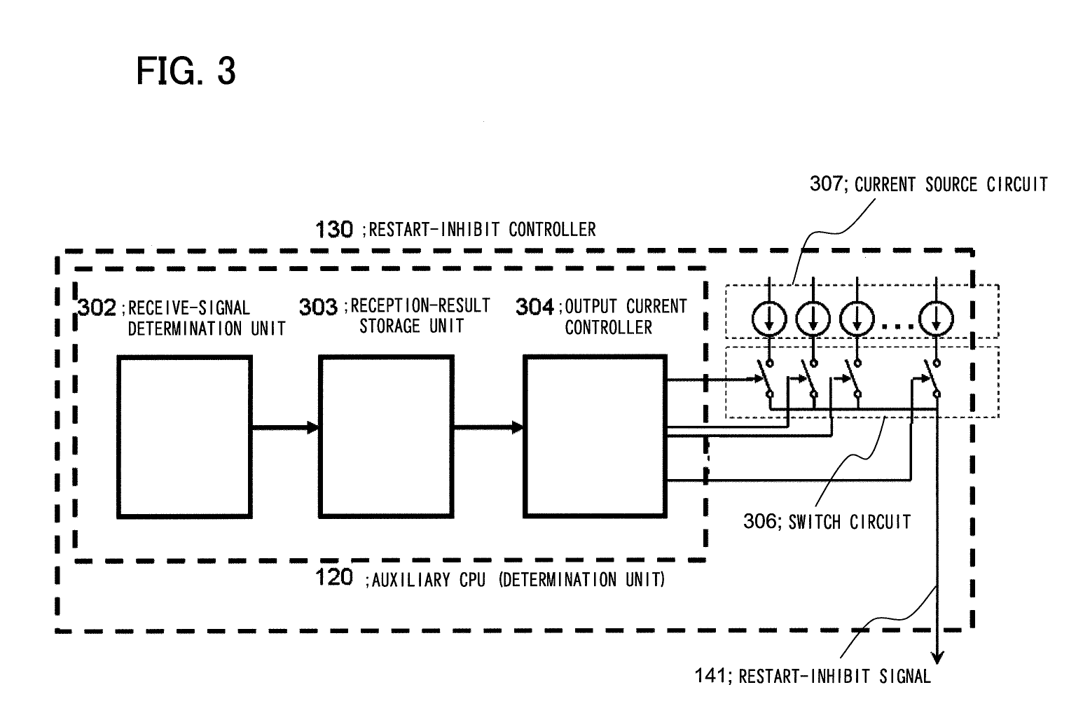

FIG. 3 is a block diagram illustrating the internal configuration of the restart-inhibit controller 130 in somewhat greater detail. The auxiliary CPU 120 functions as a determination section 120 having a receive-signal determination unit 302, a reception-result storage unit 303 and an output current controller 304. Further, a current source circuit 307 and a switch circuit 306 function as the DA converter 112 and output the restart-inhibit signal 141, which is the signal that decides the time period over which restart is inhibited, to the start circuit 115 as a current output signal.

The receive-signal determination unit 302 determines whether the demodulated signal is the desired signal. The reception-result storage unit 303 stores a count value which, if the demodulated signal is not the desired signal, indicates how many times in succession the demodulated signal was not the desired signal. The count value shall be referred to as a successive reception failure count Nfail. On the basis of the successive reception failure count Nfail, the output current controller 304 controls the switch circuit 306, decides the output current value of the restart-inhibit signal 141 and controls the time over which restart is inhibited.

Further, the current source circuit 307 is constituted by an N-bit (where N is a natural number) current source, in which the current value of a kth bit (where k is a natural number less than N) has been weighted by 2^{(k-1)}×Io. That is, the current source circuit 307 is so adapted that currents Io, 2×Io, 4×Io, 8×Io, . . . are output in order starting from the first bit.

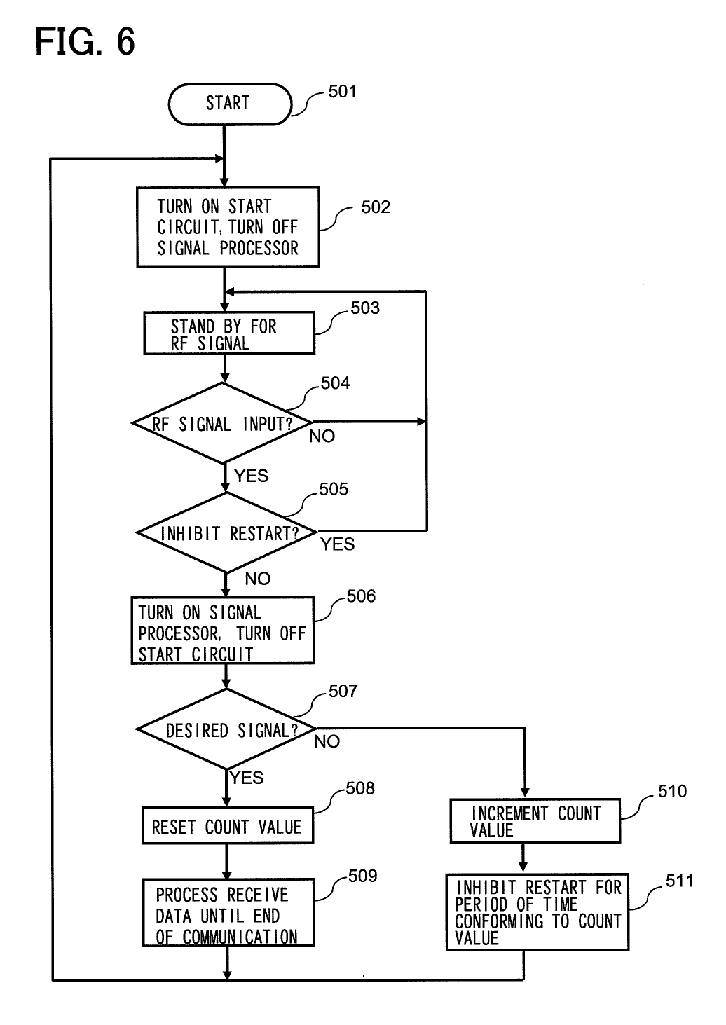

Next, the operation of the receiver according to the first exemplary embodiment will be described with reference to the operation flowchart of FIG. 6. When the receiver starts operating at step 501, initial settings are made, after which the start circuit 115 is placed in the operating state, the receive-signal processor 114 is placed in the sleep state and the standby state is attained (step 502). Since operation of the receive-signal processor 114 ceases under these conditions, an operating current does not flow into the receive-signal processor 114. Further, since the start circuit 115 is composed of an analog circuit and a simple logic circuit, the operating current thereof is much smaller than that of the receive-signal processor 114.

In the standby state (step 502), any charge that accumulated in the capacitor 108 will have been discharged to the clamp(ground) level via the resistor 107 and therefore the restart-inhibit signal 141 will be at the potential of the clamp(ground) level. Accordingly, the output of the binarizing circuit 109 is at the high level (the reverse logic level of the ground level).

In a case where there is no signal at the RF signal input terminal 101 or in a case where there is an input signal but the input signal detected and amplified by the matching circuit 102, detecting circuit 103 and amplifying circuit 104 does not reach the threshold level of the binarizing circuit 105, the output of the binarizing circuit 105 is the low level. Accordingly, the output of the AND gate 106 is the low level and the standby state is maintained (“NO” at step 504).

On the other hand, if an RF signal of the desired frequency band is input to the RF signal input terminal 101 and the signal exceeds the threshold level of the binarizing circuit 105, then the binarizing circuit 105 outputs the high level (“YES” at step 504). In this case, since the restart-inhibit signal 141 is at the low level (“NO” at step 505), the output of the binarizing circuit 109 is the high level, as mentioned above, the AND gate 106 changes state and the start signal 113 is raised to the high level.

The receive-signal processor 114 receives the high level of the start signal 113, quits the sleep state and attains the operating state. When the auxiliary CPU 120 attains the operating state, it places a start-circuit control signal 142 at the low level and places the start circuit 115 in the sleep state (step 506).

The receive-signal processor 114 inputs the RF signal, which has entered from the RF signal input terminal 101, to the demodulating circuit 110 to thereby reconstruct the digital signal. The auxiliary CPU 120 determines whether the demodulated signal is the desired signal (step 507). If the demodulated signal is the desired signal (“YES” at step 507), then the count value of the successive reception failure count Nfail stored by the reception-result storage unit 303 is made zero by the auxiliary CPU 120 (step 508). The main CPU 121 executes receive-data signal processing until communication ends (step 509). When communication ends, the auxiliary CPU 120 places the start-circuit control signal 142 at the high level to thereby place the start circuit 115 in the operating state, after which the receive-signal processor 114 ceases operation and the standby state is restored (step 502).

On the other hand, if the auxiliary CPU 120 determines that the signal is not the desired signal (“NO” at step 507), it increments the successive reception failure count Nfail stored by the reception-result storage unit 303 (step 510). An instance where the signal is not the desired signal corresponds to a case where reception has failed for some reason, e.g., a case where the demodulated signal is not a signal directed to this receiver but is a call signal directed to another communication apparatus, or a case where the demodulating circuit 110 cannot demodulate the input signal to a meaningful signal. Next, the restart-inhibit controller 130 outputs the restart-inhibit signal 141 (step 511) based upon the count value of the successive reception failure count Nfail, and then places the start-circuit control signal 142 at the high level to thereby place the start circuit 115 in the operating state. The receive-signal processor 114 ceases operation and the standby state is stored (step 502).

The relationship between operation of the restart-inhibit controller 130 and the time during which restart is inhibited will now be described in detail.

On the basis of the information indicated by the successive reception failure count Nfail stored in the reception-result storage unit 303, the output current controller 304 controls the switch circuit 306 in such a manner that the output current value of the restart-inhibit signal 141 in increased to the extent that the successive reception failure count Nfail increases. More specifically, when the value of the successive reception failure count Nfail is k (where k is a natural number less than N and n represents the number of bits of the switch circuit 306 and current source circuit 307), the output current controller 304 controls the switch circuit 306 so as to turn on the switch of the kth bit and turn off the switches of the other bits. As already mentioned, the current value of each bit (kth bit) of the current source circuit 307 has been weighted in such a manner that the current amount Io of the first bit is multiplied by the (k-1)th power of 2. That is, when the value of the successive reception failure count Nfail is k, the output current value of the restart-inhibit signal 141 becomes an output current value that is the (k-1)th power of 2 times the current amount Io of the first bit.

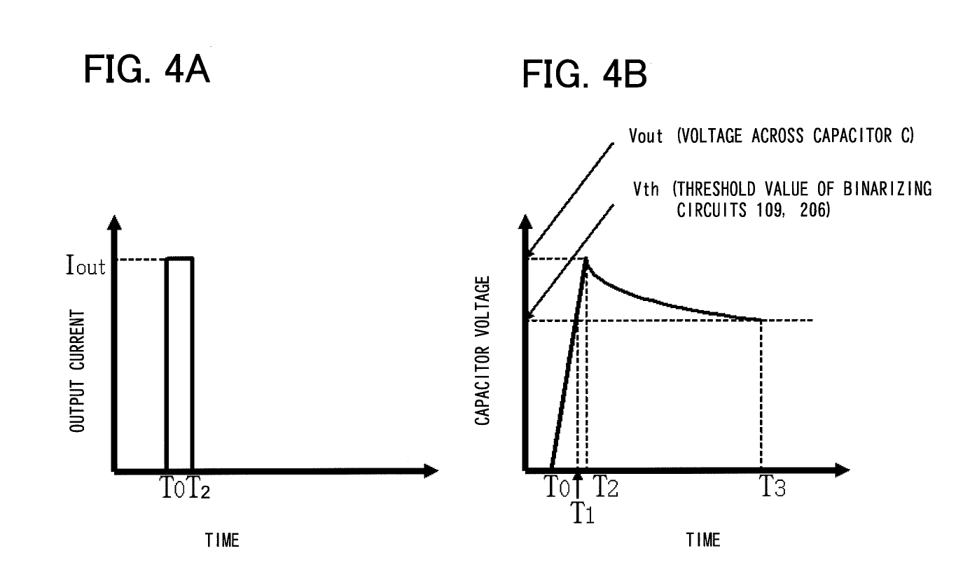

FIGS. 4A and 4B are waveform diagrams of the output current and output voltage, respectively, of the restart-inhibit signal 141. FIGS. 4A and 4B assume a case where the value of the successive reception failure count Nfail has changed from zero to one. FIG. 4A illustrates the output current value of the restart-inhibit signal 141 that is output from the restart-inhibit controller 130, and FIG. 4B illustrates the voltage value of the restart-inhibit signal 141. Since the value of the successive reception failure count Nfail is one, the output current controller 304 turns on the first bit of switch circuit 306 for a fixed period of time T0 to T2. Accordingly, a current Iout is output as the restart-inhibit signal 141 from T0 to T2, as illustrated in FIG. 4A. As a result, the voltage of the restart-inhibit signal 141 charges the capacitor 108 for the period from T0 to T2 and the voltage of the restart-inhibit signal 141 exceeds the logical threshold level of the binarizing circuit 109 at timing T1, as shown in FIG. 4B. From timing T2 onward, the charge in capacitor C is discharged gradually to the clamp(ground) level owing to the resistor 107 and therefore the voltage level of the restart-inhibit signal 141 gradually declines and falls to the logical threshold level of the binarizing circuit 109 again at timing T3. Over the period of time from timing T1 to timing T3, the voltage of the restart-inhibit signal 141 is above the logical threshold level of the binarizing circuit 109 and the output of the binarizing circuit 109 is at the low level. Therefore, regardless of the level of the RF signal that enters from the RF signal input terminal 101, the start circuit 115 does not output the start signal 113. That is, owing to the restart-inhibit signal 141, the output of the start signal 113 is inhibited from timing T1 to timing T3.

FIGS. 5A and 5B are waveform diagrams of the output current and output voltage, respectively, of the restart-inhibit signal 141 in a case where the successive reception failure count Nfail is incremented from a value other than zero (Nfail-1). FIGS. 5A and 5B assume a case where, as a result of attempts by the demodulating circuit 110 to perform demodulation, the signal obtained was determined not to be the desired signal Nfail times in succession. FIG. 5A illustrates the output current value of the restart-inhibit signal 141 that is output from the restart-inhibit controller 130, and FIG. 5B illustrates the voltage value of the restart-inhibit signal 141.

First, in a case where reception has failed for the (Nfail-1)th time in succession, the output current controller 304 turns on the (Nfail-1)th bit of the switch circuit 306 for a fixed period of time Tn to Tn+1. Accordingly, a current that is the result of multiplying lout by the (Nfail-1)th power of 2 is output as the restart-inhibit signal 141 from Tn to Tn+1, as illustrated in FIG. 5A. As a result, as illustrated in FIG. 5B, the voltage of the restart-inhibit signal 141 charges the capacitor 108 for the period from Tn to Tn+1, the voltage of the restart-inhibit signal 141 exceeds the logical threshold level of the binarizing circuit 109 and the output of the start signal 113 is inhibited. The charge that has accumulated in the capacitor 108 is subsequently discharged gradually by the resistor 107, the voltage falls to a voltage below the logical threshold level of the binarizing circuit 109 at timing Tn+2, and the inhibition on the output of the start signal 113 is removed.

Next, if reception fails one more time in succession, the output current controller 304 turns on the (Nfail)th bit of the switch circuit 306 for a fixed period of time Tn+3 to Tn+4. Since the (Nfail)th bit of the current source circuit 307 passes a current that is twice that of the (Nfail-1)th bit of the current source circuit 307, a current that is the result of multiplying Iout by the (Nfail)th power of 2 is output as the restart-inhibit signal 141 from Tn+3 to Tn+4, as illustrated in FIG. 5A. As a result, as illustrated in FIG. 5B, the voltage of the restart-inhibit signal 141 charges the capacitor 108 for the period from Tn+3 to Tn+4, the voltage of the restart-inhibit signal 141 exceeds the logical threshold level of the binarizing circuit 109 and the output of the start signal 113 is inhibited. The charge that has accumulated in the capacitor 108 is subsequently discharged gradually by the resistor 107, the voltage falls to a voltage below the logical threshold level of the binarizing circuit 109 at timing Tn+5, and the inhibition on the output of the start signal 113 is removed. However, since the current value that is output as the restart-inhibit signal 141 from Tn+3 to Tn+4 is twice the current value that is output from Tn to Tn+1, the period of time from the moment the output of the start signal 113 is inhibited to the moment the inhibition on the output is removed also is lengthened.

More specifically, as a result of an attempt by the demodulating circuit 110 to perform demodulation, the period of time over which the output of the start signal 113 is inhibited is lengthened to the extent that the signal obtained continues not to be the desired signal. In a case where the demodulated signal is not the desired signal, it is highly likely that another station using the same frequency band as that of this apparatus and employing the same communication protocol is communicating, and it is conceivable that the other station will be communicating for a while longer. In such case there is a high probability that the desired signal will not be obtained even if demodulation is tried continuously without leaving some time idle. Accordingly, instances of erroneous start-up can be reduced by the function of this exemplary embodiment that prolongs restart-inhibit time as the successive reception failure count Nfail increases. Further, even in a case where the start circuit initiates start-up as a result of ambient noise being misrecognized as communication directed to this apparatus, restart is inhibited until such ambient noise diminishes. It is thus possible to suppress consumption of needless operating current.

It should be noted that even if the successive reception failure count Nfail increases, the current value of the restart-inhibit signal 141 will not increase beyond the current value of the most significant bit of the current source circuit 307 or beyond the sum total of the current values of all bits of the current source circuit 307. It goes without saying, therefore, that the time over which start is inhibited will not be prolonged without limit.

Further, in order to further reduce the current that flows when the start circuit 115 and receive-signal processor 114 are not operating (i.e., when they are in the sleep state), the power sources of the start circuit 115 and receive-signal processor 114 may be cut off at such time. However, in a case where the power source of the reception-result storage unit 303 of the determination unit 120 also is cut off, it is required that the reception-result storage unit 303 be made a non-volatile memory. On the other hand, if the leakage current when operation has ceased (i.e., in the sleep state) is so small in comparison with the operating current that it will not pose a problem, it will suffice to suspend operation while this current continues to be passed. Further, in order to hasten restart and reduce leakage current, the power-source voltage at the time of the sleep state may be lowered. In any case, in accordance with this exemplary embodiment, the operating current of the receiver can be reduced and, as a result, so can the power consumption of the receiver.

### Second Exemplary Embodiment

FIG. 2 is a block diagram of a receiver according to a second exemplary embodiment. Blocks in FIG. 2 having substantially the same functions as those shown in FIG. 1 are designated by like reference numerals and need not be described again in detail. In the receiver of the second exemplary embodiment, the binarizing circuit 109, detecting circuit 103, amplifying circuit 104 and binarizing circuit 105 of FIG. 1 are replaced by a binarizing circuit 206, detecting circuit 203, amplifying circuit 204 and binarizing circuit 205, respectively. Further, a sleep signal 216 that is output by the binarizing circuit 206 is connected to the detecting circuit 203, amplifying circuit 204 and binarizing circuit 205. The sleep signal 216 is at the high level when start circuit 215 is operating. When the voltage level of the restart-inhibit signal 141 is above a fixed reference voltage, the binarizing circuit 206 places the sleep signal 216 at the low level, thereby suspending operation of the detecting circuit 203, amplifying circuit 204 and binarizing circuit 205. On the other hand, when the voltage level of the restart-inhibit signal 141 is below the fixed reference level, the binarizing circuit 206 outputs the high level. At this time the detecting circuit 203, amplifying circuit 204 and binarizing circuit 205 operate. Further, when the sleep signal 216 is at the low level, the binarizing circuit 205 places the start signal 213 at the low level irrespective of the output voltage of the amplifying circuit 204. That is, when the restart-inhibit signal 141 is above the fixed reference voltage, the sleep signal 216 is at the low level and therefore so is the start signal 213. As a consequence, the receive-signal processor 114 is not restarted by the start signal 213.

It should be noted that when the receive-signal processor 114 outputs the restart-inhibit signal 141 in response to reception failure, suspends operation and restores the standby state, the detecting circuit 203, amplifying circuit 204 and binarizing circuit 205 of the start circuit 215 also cease operating simultaneously. That is, the second exemplary embodiment is such that if reception fails, the receive-signal processor 114 and the detecting circuit 203, amplifying circuit 204 and binarizing circuit 205 of the start circuit 215 are placed in the sleep state simultaneously for a fixed period of time. In comparison with the first exemplary embodiment, therefore, operating current can be reduced to a greater degree. Furthermore, when the fixed period of time elapses and the sleep signal 216 attains the high level, the detecting circuit 203, amplifying circuit 204 and binarizing circuit 205 are removed from the sleep state and the normal standby state is restored.

Though the present invention has been described in accordance with the foregoing embodiments, the invention is not limited to these embodiments and it goes without saying that the invention covers various modifications and changes that would be obvious to those skilled in the art within the scope of the claims.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A receiver, comprising:
a start circuit that detects a radio-frequency signal and outputs a start signal if a level of the detected radio-frequency signal is no less than a fixed level, and
a receive-signal processor that receives the start signal and starts a demodulating operation for demodulating the radio-frequency signal, wherein said receive-signal processor includes:
a demodulator that reconstructs a demodulated signal from the radio-frequency signal; and
a restart-inhibit controller that determines whether the demodulated signal is a desired signal and, if the demodulated signal is not a desired signal, outputs a restart-inhibit signal to said start circuit and causes said start circuit to inhibit output of the start signal for a fixed period of time.

2. The receiver according to claim 1, wherein said start circuit includes a time-constant circuit for receiving a restart-inhibit signal and inhibiting output of the start signal for a fixed period of time.

3. The receiver according to claim 1, wherein whenever said receive-signal processor starts operating in response to receipt of the start signal from said start circuit, said restart-inhibit controller determines whether the demodulated signal is a desired signal and, if the demodulated signal is not the desired signal, counts the number of times the demodulated signal is not the desired signal and outputs the restart-inhibit signal in such a manner that the time over which the output of the start signal is inhibited is lengthened to the extent that the number of times the demodulated signal is not the desired signal continues.

4. The receiver according to claim 1, wherein said restart-inhibit controller comprises:
a determination unit that determines whether the demodulated signal is a desired signal whenever the receive-signal processor starts operating in response to receipt of the start signal from said start circuit, counts the number of times the demodulated signal is not the desired signal if the demodulated signal is not the desired signal, and resets the value of the count if the demodulated signal is the desired signal; and
a DA converter that outputs a current which conforms to the value of the count;
wherein the restart-inhibit signal is the current signal that is output from said DA converter.

5. The receiver according to claim 1, wherein said start circuit comprises:
a capacitor that is charged by the restart-inhibit signal;
a fixed resistor that discharges a charge accumulated in said capacitor; and
a comparison circuit that inhibits the output of the start signal if the charge that has been charged in said capacitor is equal to or greater than a prescribed voltage.

6. The receiver according to claim 1, wherein said start circuit ceases operating for a fixed period time in response to receipt of the restart-inhibit signal.

7. The receiver according to claim 5, wherein said start circuit further comprises:
a matching circuit that receives a radio-frequency signal of a prescribed frequency band efficiently;
a detecting circuit that detects in analog form the radio-frequency signal that has been matched by said matching circuit;
an amplifying circuit that amplifies an output from said detecting circuit; and
a start-signal output circuit that outputs the start signal if the detection signal amplified by said amplifying circuit is equal to or greater than a prescribed voltage;
wherein said comparison circuit suspends operation of said detecting circuit, said amplifying circuit and said start-signal output circuit if the charge that has been charged in said capacitor is equal to or greater than a prescribed voltage.

8. A method of reducing operating current of a receiver having a start circuit and a receive-signal processor, said method comprising:
in a standby state, the start circuit operating and the receive-signal processor ceasing operation;
when the start circuit detecting a radio-frequency signal and a level of the detected radio-frequency signal is no less than a fixed level, starting the receive-signal processor to perform a demodulating operation for reconstructing a demodulated signal from the radio-frequency signal and suspending operation of the start circuit;
when the demodulated signal is a desired signal, continuing signal-receive processing until end of communication and returning to the standby state; and
when the demodulated signal is not a desired signal, setting the start circuit in such a manner that it will not start the receive-signal processor for a fixed period of time, and returning to the standby state.

9. The method according to claim 8, wherein when the receive-signal processor continuously detects that the demodulated signal is not a desired signal, the fixed period of time is prolonged in proportion with the number of times in succession the demodulated signal is not the desired signal.

10. The method according to claim 8, wherein when the demodulated signal is not the desired signal, both operations of the start circuit and the receive-signal processor are stopped for the fixed period of time and the receiver return to the standby state after the fixed period of time.
